(19) United States
(12) Patent Application Publication
(10) Pub. No.: US 2011/0266411 A1
(43) Pub. Date: Nov. 3, 2011

(54) ERGONOMICALLY BALANCED AND MOVEABLE ARM SUPPORT SYSTEM

(76) Inventors: David Silverberg, Larkspur, CA (US); Howard Silverberg, Los Gatos, CA (US); Aaron Silverberg, San Diego, CA (US); Edward Silverberg, San Diego, CA (US)

(21) Appl. No.: 12/970,870

(22) Filed: Dec. 16, 2010

Related U.S. Application Data
(60) Provisional application No. 61/329,242, filed on Apr. 29, 2010.

(51) Int. Cl. A47B 97/00; F16B 2/06; F16F 7/00; F16F 15/00

(52) U.S. Cl. 248/634; 248/118; 248/636

(57) ABSTRACT

An ergonomically balanced arm support system to counterbalance the weight of the human arm is described. The arm support system includes a fastening mechanism, a vertical sliding support attached to the fastening mechanism, and an adjustable counterbalancing device which includes a tension wire. The adjustable counterbalancing device is attached to the vertical sliding support by an attachment mechanism. The arm support system further includes a horizontal pivoting support arm which includes a segment, a human arm support, and a vertical sliding mechanism. The vertical sliding mechanism includes a wire attachment, and the tension wire of the adjustable counterbalancing device is attached to the wire attachment of the vertical sliding mechanism. The vertical sliding mechanism is coupled to the vertical sliding support such that the horizontal support arm is capable of providing a substantial range of motion in a substantially vertical direction, and the horizontal support arm is further capable of providing a substantial range of motion in an additional direction. The additional direction is substantially perpendicular to the substantially vertical direction.

### CROSS REFERENCE TO RELATED APPLICATIONS

This application claims priority to U.S. Provisional Application Ser. No. 61/329,242, filed on Apr. 29, 2010, which is incorporated herein for all purposes.

### TECHNICAL FIELD

This invention relates to mechanical support systems, particularly ergonomic arm supports.

### BACKGROUND

Ergonomic devices for providing support to human arms are widely used in the workplace and for those with motor impairments. There are numerous arm support solutions depending upon ergonomic need. Arm support devices typically provide essential support to the operator via padded ergonomic arm rests, and horizontal movement via the use of pivot jointed arms. Some designs also include vertical support via the use of springs. Typical arm supports of this type are shown, for example, in U.S. Pat. No. 7,222,826 (Berglund), issued on May 29, 2007, U.S. Pat. No. 5,074,501 (Holtta), issued on Dec. 24, 1991, U.S. Pat. No. 6,142,570 (Bergsten et. al.), issued on Nov. 7, 2000, U.S. Pat. No. 6,923,505 (Siminovitch et. al.), issued on Aug. 2, 2005, U.S. Pat. No. 5,536,070 (Lemmen), issued on Jul. 16, 1996, and U.S. Pat. No. 5,884,974 (Bergsten et. al.), issued on Mar. 23, 1999. Torque reaction arms or parallel arms have also been used to minimize forces on the human operator in the industrial setting, for example by providing counterbalancing support for tools being utilized by the human operator. Examples of these types of devices are shown, for example, in U.S. Pat. No. 5,213,292 (Evans), issued on Jul. 16, 1996, and U.S. Pat. No. 4,969,625 (Singer et. al.), issued on Nov. 13, 1990.

Though ergonomic arm supports have achieved considerable popularity and commercial success, there has been a continuing need for improvement in the workplace. For example, recent ergonomic studies in the laboratory environment have shown that 60% to 85% of workers have musculoskeletal issues. Many of these musculoskeletal issues could have been prevented by reducing repetitive motion strain in the workplace. To date, there have been few practical solutions that provide counterbalanced human arm support, while also providing flexible movement and allowing for a substantial range of motion along two or three dimensions.

### SUMMARY

An ergonomically balanced arm support system to counterbalance the weight of the human arm is described. The arm support system can allow for a substantial range of motion of the operator's arm along two or three dimensions while simultaneously counterbalancing the weight of the operator's arm. By counterbalancing the weight of the human arm, the apparatus creates a semi-weightless vertical movement of the human arm for the operator, and reduces operator arm fatigue during use.

An apparatus for providing support to a human arm includes a fastening mechanism, a vertical sliding support attached to the fastening mechanism, and an adjustable counterbalancing device which includes a tension wire. The adjustable counterbalancing device is attached to the vertical sliding support by an attachment mechanism. The apparatus further includes a horizontal pivoting support arm which includes a segment, a human arm support, and a vertical sliding mechanism. The vertical sliding mechanism includes a wire attachment, and the tension wire of the adjustable counterbalancing device is attached to the wire attachment of the vertical sliding mechanism. The vertical sliding mechanism is coupled to the vertical sliding support such that the horizontal support arm is capable of providing a substantial range of motion in a substantially vertical direction, and the horizontal support arm is further capable of providing a substantial range of motion in an additional direction. The additional direction is substantially perpendicular to the substantially vertical direction.

For the apparatus described above, one or more of the following may be applicable. The segment of the horizontal support arm can include a slot or a rail along a length of the segment, and the human arm support is connected to the segment by way of the slot or rail such that the human arm support is capable of providing motion along the length of the segment. The segment of the horizontal support arm can be a first segment, and the horizontal support arm further includes a second segment, wherein the first segment is connected to the second segment by way of a pivoting attachment. A motion limiting or damping device can be connected to the first segment or to the second segment or within the pivoting attachment.

The fastening mechanism can be a fastening plate or a C-Clamp. The adjustable counterbalancing device can be one of an air balancer, a spring balancer, or a gas shock. The counterbalancing device can be at a higher gravitational potential than the wire attachment. The human arm support can include a padded rest, a saddle, or a sling. The vertical sliding support can be or can include a vertical track, and the vertical sliding mechanism can be configured to slide along the vertical track. The horizontal pivoting support arm can further include a horizontal pivot attachment between the vertical sliding mechanism and the segment.

The vertical sliding support can include or can be a pole, and the vertical sliding mechanism can be a shaft, where the shaft is around a diameter of the pole, and the shaft is capable of providing motion along a length of the pole with substantially low friction. The shaft can be a ball bearing lined shaft. The diameter of the pole can be substantially circular, such that the shaft is further capable of providing motion around the diameter of the pole. The attachment mechanism can be a cap which fits over an end of the pole and is capable of allowing smooth movement of the adjustable counterbalancing device around the diameter of the pole. The diameter of the pole can be in a shape of an N-sided polygon with N greater than 2, and the horizontal pivoting support arm can further include a horizontal pivot attachment between the shaft and the segment.

Motion in the substantially vertical direction can be characterized by semi-weightless vertical movement. The apparatus can further include a stopper on the tension wire, a stopper on the vertical sliding support, or a damping or motion restricting device which is capable of damping or restricting the motion in the substantially vertical direction. The vertical sliding support can be rounded or bent. The horizontal pivoting support arm can be further capable of providing a substantial range of motion in a plane, wherein a unit normal of the plane is substantially parallel to the substantially vertical direction. The horizontal pivoting support arm can further include a vertical pivot attachment. The human arm support can be capable of securing an arm, an elbow, a shoulder, or a portion of an arm. The human arm support can be connected to the segment by way of a swivel attachment. The human arm support can be a strap attached to the segment such that the strap hangs below the horizontal pivoting support arm.

### DESCRIPTION OF DRAWINGS

FIGS. 1 and 2 are side elevation views of ergonomically balanced arm support systems.

FIG. 3 is an exploded view of the elements of the arm support system of FIG. 2.

Like reference symbols in the various drawings indicate like elements.

### DETAILED DESCRIPTION

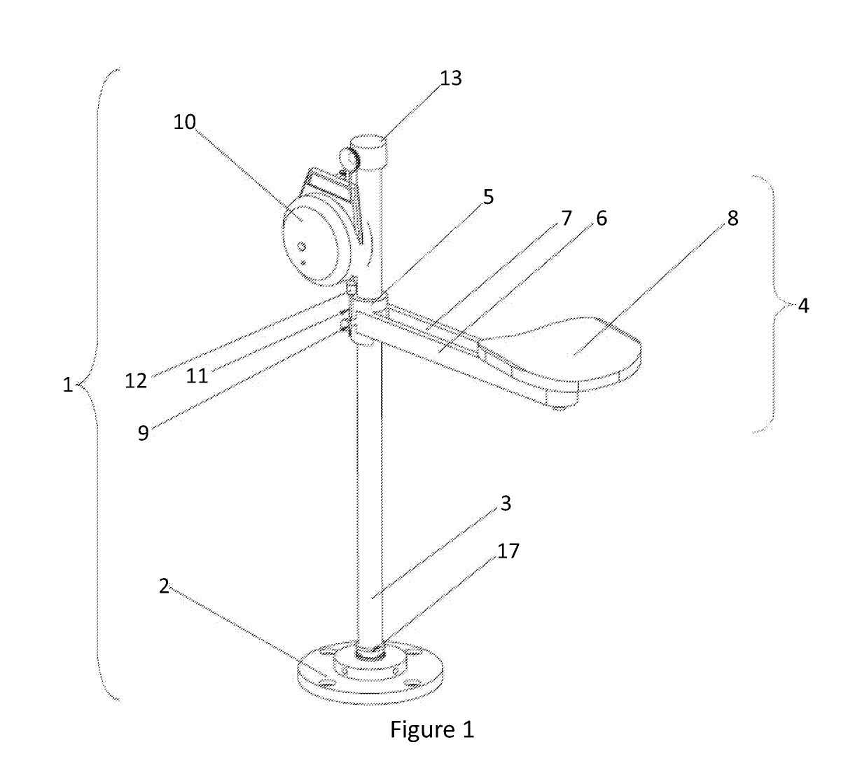

Referring to FIGS. 1-3, described herein is an ergonomically balanced arm support system to counterbalance the weight of the human arm. Considered broadly, ergonomic human arm support systems typically assist in operator movement within two or three movement axes, i.e. along two or three dimensions. The apparatus described herein includes a horizontal pivoting support arm 4 which can slide in a substantially vertical direction along a vertical sliding support 3 such as a track or pole, as well as providing a substantial range of motion either in a direction that is substantially perpendicular to the substantially vertical direction or along a plane with a unit normal that is substantially parallel to the substantially vertical direction. The horizontal pivoting support arm is counterbalanced via the use of an adjustable counterbalancing device 10, such as a spring balancer, an air balancer, or a gas shock. A tension wire 11 of the adjustable counterbalancing device 10 is attached to the horizontal pivoting support arm 4 along the length of the vertical sliding support 3. The vertical sliding support 3 is fixed, for example at its base or tip, to the space or to a surface in the vicinity of or proximal to where the operator's human arm requires balanced movement. By counterbalancing the weight of the human arm, the apparatus creates a semi-weightless vertical movement of the human arm for the operator, and reduces operator arm fatigue during use. Hence, the apparatus can allow for a substantial range of motion of the operator's arm along two or three dimensions while simultaneously counterbalancing the weight of the operator's arm. As used herein, “semi-weightless” motion or movement refers to movement of an object and/or a human body part along the direction of the Earth's gravitational field for which the weight of the object and/or human body part is counterbalanced by a force approximately equal in magnitude to the object's and/or human body part's weight, but in an opposite direction. Hence, the net force on the object and/or human body part is close to zero, creating a sensation resembling that which would be experienced in the absence of gravity acting on the object and/or human body part.

Referring to FIG. 1, an apparatus 1 for providing support to a human arm can include a fastening mechanism 2, such as a fastening plate or a C-Clamp, as is known in the art, a vertical sliding support 3, such as a pole or a track, attached to the fastening mechanism 2, an adjustable counterbalancing device 10 which includes a tension wire 11, and a horizontal pivoting support arm 4 which includes a vertical sliding mechanism 5 with a wire attachment 9, a segment 6, and a human arm support 8. The fastening mechanism 2 can secure the apparatus to the location in which it is to be used. For example, the fastening mechanism 2 can secure the apparatus to the surface of a work bench. The vertical sliding support 3, which is attached to the fastening mechanism 2, can be aligned in a substantially vertical direction, i.e., approximately along the gradient of the gravitational field. The vertical sliding mechanism 5 is coupled to the vertical sliding support 3 such that the horizontal support arm 4 is capable of providing a substantial range of motion in a substantially vertical direction, for example at least about 6 inches, at least about 12 inches, or at least about 18 inches of vertical range.

As seen in FIG. 1, in one implementation the vertical sliding support 3 is a pole, and the vertical sliding mechanism 5 is a shaft, such as a ball bearing lined shaft. The shaft 5 can be placed around a diameter of the pole 3, whereby the shaft 5 is able to slide along a length of the pole 3 with substantially low friction. A stopper 17 can be placed on the pole to limit the vertical motion of the horizontal pivoting support arm 4. In some implementations, the diameter of the pole 3 is substantially circular, and the shaft is further capable of providing motion, such as rotation, around the diameter of the pole 3.

The adjustable counterbalancing device 10 can, for example, be a spring balancer, an air balancer, or a gas shock. Spring balancers, which have been historically used in assembly and manufacturing applications to support assembly tools, are described in U.S. Pat. No. 2,072,582 (Douglass), issued on Mar. 2, 1937, and U.S. Pat. No. 2,078,489 (Forss), issued on Apr. 27, 1937. The adjustable counterbalancing device 10 is attached to the vertical sliding support 3 by an attachment mechanism 13 and is placed in a position which is higher (i.e., at a higher gravitational potential) than the wire attachment 9. In some implementations, the attachment mechanism 13 is attached to an end of the vertical sliding support 3. In the case that the vertical sliding support 3 is a pole, the attachment mechanism 13 can be a cap which can fit over an end of the pole. In this case, if the pole has a substantially circular diameter, the cap can be made to rotate, thereby allowing smooth movement of the adjustable counterbalancing device 10 around the diameter of the pole. The tension wire 11 of the adjustable counterbalancing device 10 is connected to the wire attachment 9, which for example can be a circular clip. As the horizontal pivoting support arm 4 moves up and down, the tension wire 11 extends and retracts at a tension force set by the operator to counterbalance the weight of the human arm and the entire horizontal pivoting support arm 4. A stopper 12, such as a protective rubber stopper, can be placed on the tension wire 11 to prevent damage to the adjustable counterbalancing device 10 in case the tension wire 11 retracts and quickly pulls the horizontal pivoting support arm 4 upwards.

Horizontal pivoting support arm 4 is designed to support the operator's arm while allowing a substantial range of motion along two or three dimensions. The human arm support 8 is capable of securing an arm, an elbow, a shoulder, or a portion of an arm. The operator places a shoulder or a portion of the arm requiring counterbalanced motion in the human arm support 8, which for example can be a padded rest, a saddle, or a sling. The vertical sliding mechanism 5 can slide up and down the vertical sliding support 3, thereby providing a substantial range of motion for the arm in a vertical direction. In the case where the vertical sliding support 3 is a pole with a substantially circular diameter and the vertical sliding mechanism 5 is a ball bearing lined shaft, the segment 6 can rotate around the diameter of the pole. Furthermore, the segment 6 includes a slot or rail 7 along the length of the segment. The human arm support 8 is connected to the segment 6 by way of the slot or rail such that the human arm support is capable of providing motion along the length of the segment. Hence, the horizontal pivoting support arm 4 is capable of providing a substantial range of motion in a horizontal plane, for example at least about 6 inches, at least about 12 inches, or at least about 18 inches of motion in any horizontal direction.

In some implementations, the vertical sliding support 3 is a pole with a diameter in the shape of an N-sided polygon with N greater than 2, for example a square or rectangle, and the vertical sliding mechanism 5 is a shaft, such as a ball bearing lined shaft. In this case, a horizontal pivot attachment (not shown) can be included between the shaft 5 and the segment 6. The horizontal pivot attachment allows for rotation of the segment 6 about the edge of the shaft 5. In other implementations, the vertical sliding support 3 is a vertical track, and the vertical sliding mechanism 5 is configured to slide along the vertical track. In this case, a horizontal pivot attachment (not shown) can also be included between the vertical track and the segment 6.

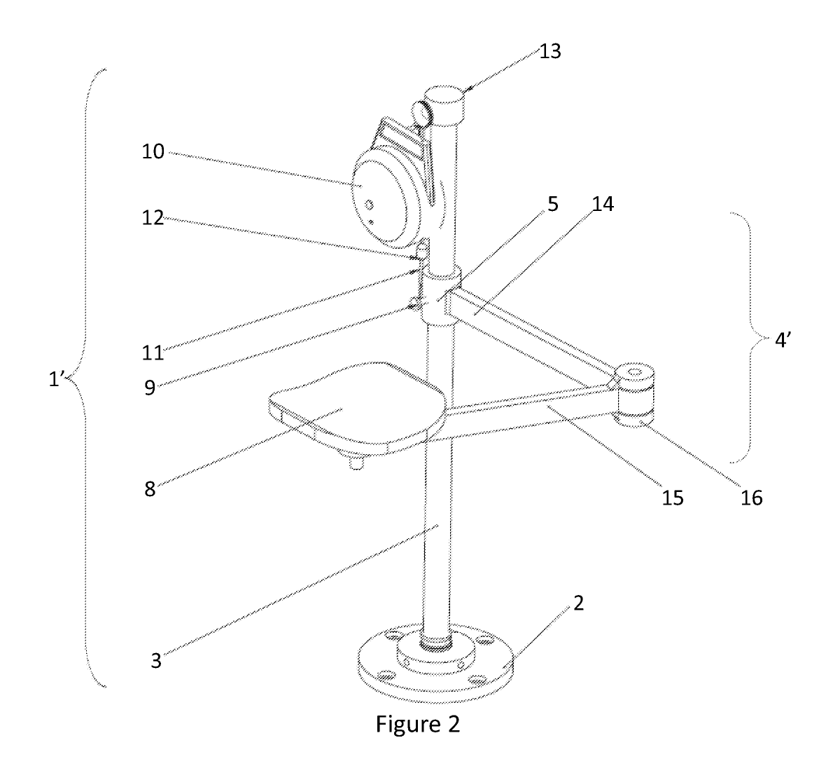

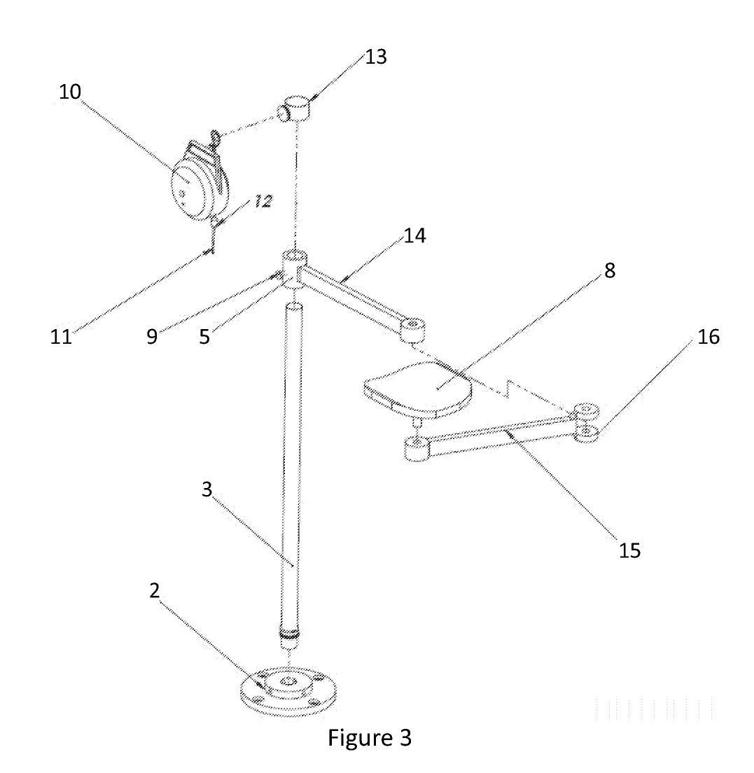

The apparatus 1′, shown in FIGS. 2-3, is the same as apparatus 1 of FIG. 1, except that the horizontal pivoting support arm 4′ is modified as compared to that of apparatus 1 in FIG. 1. Referring to FIGS. 2-3, the horizontal pivoting support arm 4′ can include a first segment 14 and a second segment 15 connected by way of a pivoting attachment. An outside edge of the vertical sliding mechanism 5 is fastened or welded to the first segment 14. At the end of the first segment 14 opposite the vertical sliding mechanism 5, a pivot joint 16 connects the first segment 14 to the pivot joint of the second segment 15. Within the pivot joint is a shaft and bearing assembly to allow the two horizontal segments to turn freely in a horizontal fashion.

In some applications, it may be advantageous for the human arm support 8 of apparatus 1/1′ to be able to swivel about its connection to the horizontal pivoting support arm 4/4′, as this can provide additional flexibility of motion to the operator. As such, the human arm support 8 can be connected to a segment of the horizontal pivoting support arm 4/4′ by way of a swivel attachment, such as a ball attachment or a flexible or semi-flexible rubber post. A flexible or semi-flexible rubber post may be advantageous in that it provides a force which restores the human arm support 8 to its equilibrium position.

The apparatus 1/1′ of FIGS. 1-3 is operated as follows. The operator places a forearm on the arm rest 8, and sets the tension of the adjustable counterbalancing device 10 to counterbalance the weight of the arm. Once the tension of the adjustable counterbalancing device 10 is properly set, the operator moves the arm vertically along the vertical sliding support 3, or in a horizontal plane with the horizontal pivoting support arm 4/4′, via the use of the forearm saddled in the arm rest 8.

In some implementations, it can be necessary or preferable to secure the operator's arm into the human arm support 8 to prevent slipping. As such, the human arm support 8 can for example be an arm rest or a saddle with a strap that can be tightened around the operator's arm in order to secure the arm to the arm rest or saddle. Or, as another example, the human arm support 8 can be an adjustable strap, where the operator can insert the arm into the strap and tighten the strap around the arm. In this case, the strap may hang below the horizontal pivoting support arm 4/4′ to which it is connected. Alternatively, the portion of the human arm support 8 which contacts the operator's arm can be constructed of a high-friction material, which can prevent slipping without the need for a securing mechanism such as a strap or velcro.

The apparatus 1/1′ of FIGS. 1-3 can be used in a variety of applications for which counterbalanced motion is desired. For example, the apparatus can provide ergonomic support for repetitive tasks performed in a laboratory, such as repeated use of a pipette at a lab bench or table. In some implementations, the apparatus described herein is used in a confined space, such as within a fume hood. In cases like this, it can be beneficial to dampen or limit the motion or range of motion allowed by the apparatus. As such, the apparatus 1/1′ of FIGS. 1-3 can further include a damping or motion restricting device which is capable of damping or restricting the motion along the vertical sliding support 3. Or, apparatus 1′ of FIGS. 2-3 can further include a motion limiting or damping device connected to the first segment 14, or to the second segment 15, or within the pivoting attachment.

Some applications in which the apparatus 1/1′ can be utilize require precise motion and placement of the arm by the operator. For example, the operator may need to pour liquid from a pipette into a very small vial or container on a lab bench, requiring very precise placement and movement of the counterbalanced arm. In these applications, it may be advantageous for the operator to be able to rest a portion of his or her counterbalanced arm, such as an elbow, upon the lab bench or other surface. This can be difficult to achieve if the horizontal pivoting support arm 4/4′ of the apparatus 1/1′ is between the operator's arm and the lab bench or other surface. Hence, in these applications, it is preferable to utilize an adjustable strap for the human arm support 8 which hangs below the horizontal pivoting support arm 4/4′.

A number of implementations have been described. Nevertheless, it will be understood that various modifications may be made without departing from the spirit and scope of the techniques and devices described herein. For example, the vertical sliding support 3 can be rounded or bent. Or, the horizontal pivoting support arm 4/4′ can include a vertical pivot attachment. Accordingly, other implementations are within the scope of the following claims.

What is claimed is:

1. An apparatus for providing support to a human arm, comprising:
a fastening mechanism;
a vertical sliding support attached to the fastening mechanism;
an adjustable counterbalancing device comprising a tension wire, wherein the adjustable counterbalancing device is attached to the vertical sliding support by an attachment mechanism; and
a horizontal pivoting support arm comprising a segment, a human arm support, and a vertical sliding mechanism, the vertical sliding mechanism comprising a wire attachment, wherein the tension wire of the adjustable counterbalancing device is attached to the wire attachment of the vertical sliding mechanism; wherein
the vertical sliding mechanism is coupled to the vertical sliding support such that the horizontal support arm is capable of providing a substantial range of motion in a substantially vertical direction, and the horizontal support arm is further capable of providing a substantial range of motion in an additional direction, wherein the additional direction is substantially perpendicular to the substantially vertical direction.

2. The apparatus of claim 1, wherein the segment of the horizontal support arm comprises a slot or a rail along a length of the segment, and the human arm support is connected to the segment by way of the slot or rail such that the human arm support is capable of providing motion along the length of the segment.

3. The apparatus of claim 1, wherein the segment of the horizontal support arm is a first segment, and the horizontal support arm further comprises a second segment, wherein the first segment is connected to the second segment by way of a pivoting attachment.

4. The apparatus of claim 3, further comprising a motion limiting or damping device connected to the first segment or to the second segment or within the pivoting attachment.

5. The apparatus of claim 1, wherein the fastening mechanism comprises a fastening plate or a C-Clamp.

6. The apparatus of claim 1, wherein the adjustable counterbalancing device is one of an air balancer, a spring balancer, or a gas shock.

7. The apparatus of claim 1, wherein the counterbalancing device is at a higher gravitational potential than the wire attachment.

8. The apparatus of claim 1, wherein the human arm support comprises a padded rest, a saddle, or a sling.

9. The apparatus of claim 1, wherein the vertical sliding support comprises a vertical track, and the vertical sliding mechanism is configured to slide along the vertical track.

10. The apparatus of claim 9, wherein the horizontal pivoting support arm further comprises a horizontal pivot attachment between the vertical sliding mechanism and the segment.

11. The apparatus of claim 1, wherein the vertical sliding support comprises a pole, the vertical sliding mechanism comprises a shaft, the shaft is around a diameter of the pole, and the shaft is capable of providing motion along a length of the pole with substantially low friction.

12. The apparatus of claim 11, wherein the shaft is a ball bearing lined shaft.

13. The apparatus of claim 11, wherein the diameter of the pole is substantially circular, the shaft is further capable of providing motion around the diameter of the pole, and the attachment mechanism is a cap which fits over an end of the pole and is capable of allowing smooth movement of the adjustable counterbalancing device around the diameter of the pole.

14. The apparatus of claim 11, wherein the diameter of the pole is in a shape of an N-sided polygon with N greater than 2, and the horizontal pivoting support arm further comprises a horizontal pivot attachment between the shaft and the segment.

15. The apparatus of claim 1, wherein the motion in the substantially vertical direction is characterized by semi-weightless vertical movement.

16. The apparatus of claim 1, further comprising a stopper on the tension wire.

17. The apparatus of claim 1, further comprising a stopper on the vertical sliding support.

18. The apparatus of claim 1, wherein the vertical sliding support is rounded or bent.

19. The apparatus of claim 1, wherein the horizontal pivoting support arm is further capable of providing a substantial range of motion in a plane, wherein a unit normal of the plane is substantially parallel to the substantially vertical direction.

20. The apparatus of claim 1, wherein the horizontal pivoting support arm further comprises a vertical pivot attachment.

21. The apparatus of claim 1, further comprising a damping or motion restricting device which is capable of damping or restricting the motion in the substantially vertical direction.

22. The apparatus of claim 1, wherein the human arm support is capable of securing an arm, an elbow, a shoulder, or a portion of an arm.

23. The apparatus of claim 1, wherein the human arm support is connected to the segment by way of a swivel attachment.

24. The apparatus of claim 1, wherein the human arm support is a strap attached to the segment such that the strap hangs below the horizontal pivoting support arm.
